(19) United States
(12) Patent Application Publication
(10) Pub. No.: US 2006/0108765 A1
(43) Pub. Date: May 25, 2006

(54) Fender holding mechanism

(75) Inventor: Michael Teich, Mannheim (DE)

Correspondence Address: DEERE & COMPANY, ONE JOHN DEERE PLACE, MOLINE, IL, 61265, US

(73) Assignee: Deere & Company, a Delaware corporation

(21) Appl. No.: 11/270,870

(22) Filed: Nov. 9, 2005

(30) Foreign Application Priority Data
Nov. 20, 2004 (DE) 10 2004 056 025.0

(51) Int. Cl. B62D 25/18

(52) U.S. Cl. 280/157

(57) ABSTRACT

A holding mechanism for a fender for an agricultural vehicle includes a first holding element connected to an axle casing or a hub assembly of a steerable wheel of the vehicle. The holding mechanism also includes a second holding element connected to the fender and rotatably coupled to the first holding element about a generally vertical swivel axis. The holding mechanism also includes a linkage assembly which is connected to the second holding element. A steering movement of the hub assembly causes a reduced rotation of the second holding element and hence the fender in the same direction as the hub assembly. The linkage assembly is preferably connected to a steering actuator at a position which is spaced apart from the hub assembly.

### BACKGROUND

The present invention relates to a holding mechanism of a fender for an agricultural vehicle.

Tractors normally have steerable front wheels. Such wheels are often provided with a fender which is fixed to a hub assembly which holds the wheel, so that during a steering movement the fender rotates about a vertical axis in the same direction and with the same angle as the wheel. Such a design is shown in DE 34 01 631 A, and EP 0 913 320 A. However, in these designs the possible steering angle range is limited because the fender could hit against the chassis of the tractor.

A number of references (DE 34 02 754 A, EP 0 694 466 A, U.S. Pat. No. 5,074,573 A, U.S. Pat. No. 332,022 A) have suggested that the fender be coupled with the hub assembly through a spring, so that in case of impact of the fender with the chassis, the spring deforms and prevents damage to the fender and the chassis.

German patent document DE 3607000 A shows an element which is connected to the fender and which grips into an oblong hole in a plate connected to the hub. The hole is concentric to the swivel axis of the wheel, and the element is biased into a rest position therein by a spring. If the wheel is steered outwards, then it impacts with the element at the end of the oblong hole, so that the fender moves synchronous with the wheel. If the wheel is steered inwards, the spring initially presses the element against the oblong hole, so that the fender again similarly moves synchronous with the wheel. However, as soon as the holding mechanism engages an obstruction, the element moves in the oblong hole, so that the spring is compressed and the fender does not move inward any further. A similar arrangement is described in EP 0 850 820 A and in DE 200 13 118 U. The document EP 1 046 573 A suggests that, on reaching the end position, the fender be swiveled outwards with the help of a wedge or a cam face around a horizontal axis, while it is pushed outwards according to FR 2 813 847 A.

DE 3607000 A shows an alternate design wherein the fender holding mechanism is connected to the hub of the wheel and the axle casing by means of a rod arrangement which reduces the angular motion.

The document EP 0827895 A describes a similar fender holding mechanism. In this design, the fender holding mechanism is pivotally supported on the hub with a pivot axis which is parallel to the swivel axis of the wheel and spaced apart outwardly with respect to the swivel axis of the wheel. Also, the holding mechanism grips into an oblong hole in a plate connected to the axle, which extends horizontally and transverse to the driving direction. The angular rotation range of the fender is less than that of the wheel so that the fender does not engage the chassis. In a similar design, the holding mechanism is rotatably supported on the axle and grips into an oblong hole on the hub assembly.

However, if the above-described holding mechanisms are used in the environment of an agricultural tractor, a lot of dirt may collect quickly and prevent proper functioning of the springs.

The rod arrangement described in DE 3607000 A is relatively cumbersome. The similarly functioning holding mechanism shown in EP 0827895 A requires a rotary and a translatory kinematics. The latter design is very prone to trouble in the environment of a tractor. Besides, the swivel axis of the rotary kinematics is displaced outwards with respect to the swivel axis of the wheel and hence protrudes into the wheel rims. Such a holding mechanism cannot be used with smaller tire because of lack of free space.

### SUMMARY

Accordingly, an object of this invention is to provide a reliable and universally applicable holding mechanism for the fender of a tractor.

This and other objects are achieved by the present invention, wherein a holding mechanism for a fender includes a first holding element mounted on a wheel hub assembly, a second holding element coupled to the fender, and a linkage assembly. The second holding element is rotatably coupled to the first holding element about an approximately vertical rotation axis, which is generally parallel to a swivel axis of the hub assembly. The linkage assembly couples a steering actuator to the second holding element so that the holding mechanism and the fender rotate to a lesser extent than the wheels, and so that the fender does do not limit the maximum steering angle. The linkage assembly is connected directly or indirectly to the actuator at a point which is spaced apart from the hub assembly. Alternatively, the first holding element could be fixed to the adjacent axle casing instead of to the hub assembly.

The fender follows the movement of the steered wheel in both the directions. This is advantageous when a tractor moves forward and rearward between the side walls of a drive-through silo, as the fender does not hit against the silo wall.

Preferably, the linkage assembly is connected to a tie rod. The tie rod extends between the actuator (generally a steering cylinder) and a tie rod-fixing element of the hub assembly, in order to transmit the steering movement of the actuator to the hub assembly and to the wheel. The linkage assembly may be fixed to the tie rod with one or more clamps. Alternatively, the linkage assembly could be directly connected to the actuator, e.g. the piston of the steering cylinder.

The linkage assembly preferably includes a first lever and a second lever. The first lever is fixed to the second holding element. One end of the second lever is pivotally connected to the first lever, and the other end is pivotally coupled to the actuator about respective pivot axes. Both pivot axes are parallel to the rotation axis. The lever mechanism converts movement of the actuator into the desired movement of the second holding element. A desired conversion ratio can be achieved by means of suitable dimensioning of both levers. In case the hub assembly swivel axis is not parallel to the rotation axis of the second holding element, then a ball joint may be used to couple the second lever on to the actuator. As only rotation bearings are used, there is no translatory transmission, which could cause trouble.

The linkage assembly permits the rotation axis of the second holding element to be positioned inwardly from the swivel axis in a direction transverse to the forward direction, so that there is no interference with the interior of the wheel rim.

The fender assembly can be mounted on to the steerable front axles of a tractor. It could also be applied to a steerable rear axle of a tractor and/or on to the front or rear axles of other vehicles used in agriculture or construction, such as a telescopic loader or wheel loader.

### BRIEF DESCRIPTION OF THE DRAWINGS

FIG. 1 is a perspective view of a steerable front axle of a tractor with a front wheel and a fender holding mechanism;

FIG. 2 is a perspective view of the front axle and the holding mechanism in one steered position;

FIG. 3 is a perspective view of the front axle and the holding mechanism in another steered position; and

FIG. 4 is a front view of the holding mechanism and the fender.

### DETAILED DESCRIPTION

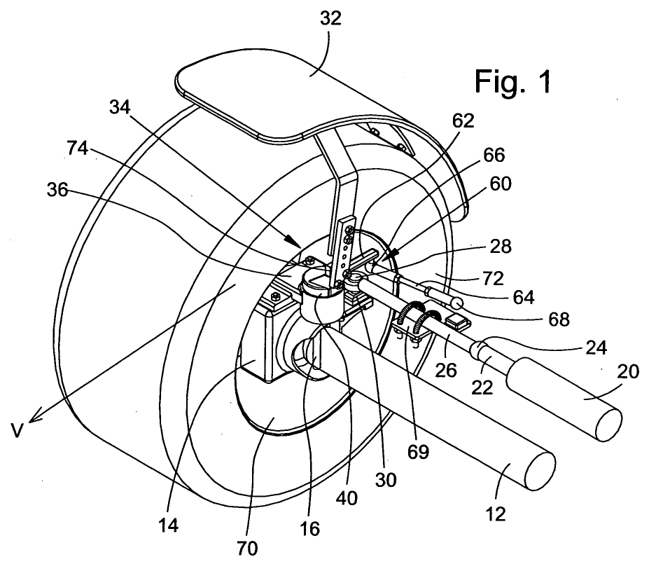

Referring to FIG. 1, the front axle 10 includes an axle casing 12 extending transverse to the forward direction V, at whose outer end a hub assembly 14 is rotatably pivoted around an approximately vertical swivel axis 16. The hub assembly 14 is connected to a flange (not visible because it is obscured by the tire 72) which supports a wheel rim 70. The wheel rim 70 with a tire 72 is mounted on the flange of the hub assembly 14. The axis 16 could be slightly inclined in a known manner against the forward direction V backwards and/or inwards and could be shifted backwards with respect to the rotation axis of the wheel rim 70. If the front axle is a drivable axle of an a tractor with all-wheel drive, then the axle casing 12 would contain a drive shaft (not shown) and the hub assembly 14 would normally contain a connecting gear (not shown).

An actuator 20, such as a hydraulic steering cylinder, generates a steering movement. The actuator includes a piston rod 22 connected to a tie rod 26 through a swivel bearing 24. The tie rod 26 is connected at its other end to a tie rod-fixing element 30 of the hub assembly 14 through another swivel bearing 28. The swivel bearings 24 and 28 are respectively rotatable around a swivel axis which extends parallel to the axis 16. A second wheel (not shown in FIG. 1), is similarly connected to the piston of the actuator 20, either by means of a piston rod running right through the cylinder or a joining rod outside the housing of the actuator 20.

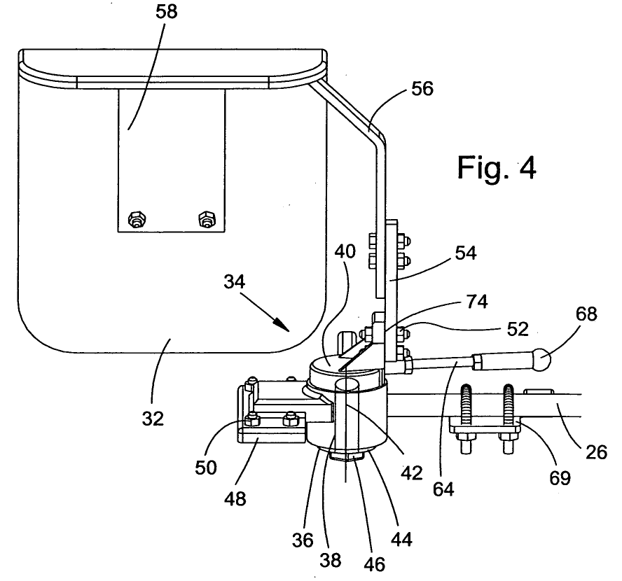

As best seen in FIGS. 1 and 4, the fender holding mechanism 34 includes a first cup-shaped holding element 36, which is fixed to and mounted on the upper side of the hub assembly 14. Holding element 36 rotatably receives cylindrical pin or second holding element 40. A threaded hole or bore 38 extends part-way from the bottom up into pin 40. Bore 38 receives the threaded shaft of bolt 46, which extends through a washer or disc 44 and the bottom end of element 36. Elements 36 and 40 define an almost vertical rotation axis 42, which can extend more or less parallel to the axis 16. As seen in FIG. 1, the rotation axis 42 is transverse to the forward direction V, and is parallel to and spaced inwardly from the axis 16 above the axle casing 12.

A flange 48 is cast on to the first holding element 36 and is bolted to the housing of the hub assembly 14 with bolts 50, and thus fastens the first holding element 36 to the hub assembly 14. Alternatively, the first holding element 36 may be integral with the housing of the hub assembly 14. The first holding element 36 may also be fixed on to a portion of the axle casing 12 adjacent to the hub assembly 14, or formed integrally with it.

The second holding element 40 is connected by a bolt 52 to a strut 54 which extends upwards, and which is bolted to a curved arm 56 which carries a support frame 58 which engages the inner side of the fender 32. The fender 32 is preferably made of plastic and bolted to the support frame 58.

When the wheel 72 is steered, the fender 32 moves along with the hub assembly 14 and the wheel, but the fender moves through a smaller angular range, to prevent the fender 32 from engaging the chassis (not shown) of the tractor. For this purpose, the invention includes a linkage assembly 60 with a first lever 62 and a second lever 64. The first lever 62 is fixed to the second holding element 40 as a single part, and is pivotally coupled with an end of the second lever 64 through a swivel bearing 66. The other end of the second lever 64 is pivoted coupled to the tie rod 26 by means of a ball joint 68. The swivel bearings 66 and the ball joint 68 respectively allow swivel movements parallel to the rotation axis 42, whereby the ball joint 68 compensates for the not necessarily parallel positions of the axes 16 and 42. If the rotation axis 42 were parallel to the axis 16, then the ball joint 68 could be replaced by a simple swivel bearing. Clamps 69 connects the tie rod to the ball joint 68. In the straight ahead position of the wheel the first lever 62 extends above the swivel bearing 68 in the forward direction, whereas the second lever 64 extends somewhat horizontally and transverse to the forward direction. The height difference between the clamps 69 and the ball joint 68 is bridged by a vertical rod.

While steering, the linkage assembly 60 transmits the movement of the tie rod 26 to the second holding element 40 and to the fender 32. This movement path is illustrated by FIGS. 1 to 3. In straight ahead position (FIG. 1), a face 74 of the second holding element 40 (which engages the strut 54), extends parallel to the forward direction V, so that the fender 32 also extends parallel to the forward direction V.

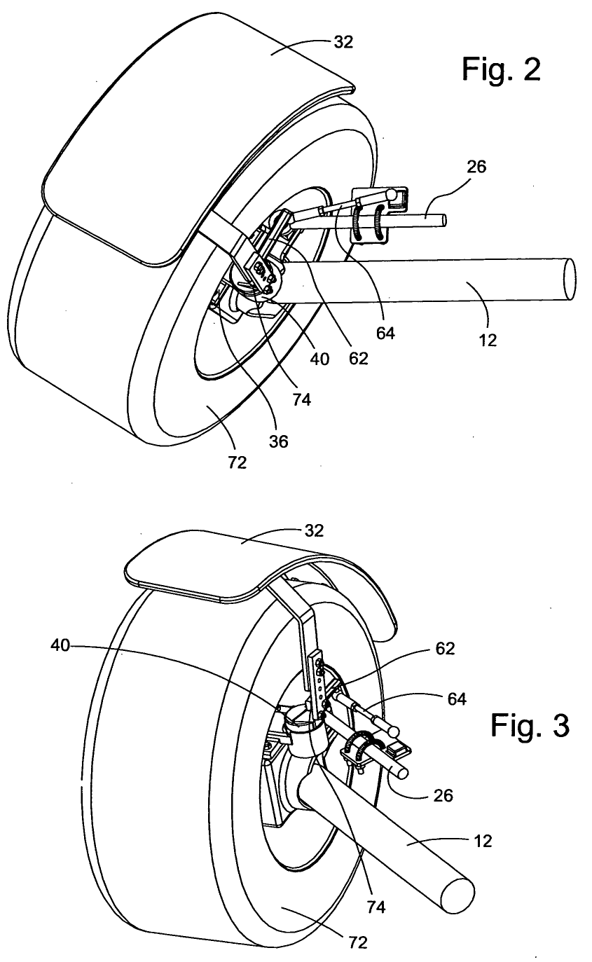

Referring now to FIG. 2, when the wheel is steered in a right turn, then the second holding element 40 and the face 74 are also steered to the right, but to a lesser extent than the hub assembly 14 with the tire 72. Similarly, as best seen in FIG. 3, the second holding element 40 and the face 74 are turned leftwardly less than the hub assembly 14. This reduced turning of the fender with respect to the hub assembly 14 prevents impact of the fender against the chassis (not shown).

The linkage assembly 60 contains only relatively few structural components and does not require transmission elements to allow a translatory movement, like oblong hole joints. Therefore, the holding mechanism 34 works reliably even in dirty environments, such as that of an agricultural tractor. Because of the selected positioning of the rotation axis 42, the holding elements 36 and 40 do not penetrate into the interior of the wheel rim 70, so that the holding mechanism 34 can be used for a very small tire diameter.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A holding mechanism for a fender for an agricultural vehicle having a steerable wheel with a hub assembly, the holding mechanism having a first holding element connected to the hub assembly, a second holding element supporting the fender and rotatably coupled to the first holding element about a generally vertically extending swivel axis, and a linkage assembly connected to the second holding element, the second holding element and the fender rotating in the same direction in response to a steering movement of the hub assembly, characterized by:
an actuator for steering the wheel; and
the linkage assembly being connected to the actuator at a connection point which is spaced apart from the hub assembly.

2. The holding mechanism of claim 1, wherein:
a tie rod extends between the actuator and a tie rod fixing element of the hub assembly, the linkage assembly being connected to the tie rod.

3. The holding mechanism of claim 1, wherein:
the linkage assembly comprises a first lever fixed to the second holding element and a second lever connected to the actuator, and said levers are rotatably coupled to each other about a pivot axis which extends parallel to the swivel axis.

4. The holding mechanism of claim 1, wherein:
the linkage assembly is connected with the actuator over an axis that extends parallel to the swivel axis.

5. The holding mechanism of claim 4, wherein:
the linkage assembly is connected to the actuator by means of a ball joint.

6. The holding mechanism of claim 1, wherein:
the hub assembly is rotatable about a rotation axis; and
the swivel axis is spaced apart inwardly with respect to the rotation axis and in a direction transverse to a forward direction of the vehicle.
